(19) United States
(12) Patent Application Publication
(10) Pub. No.: US 2015/0255860 A1
(43) Pub. Date: Sep. 10, 2015

(54) Antenna for a Bracelet Designed to Interface With a Mobile Device

(71) Applicant: MEMI LLC, Atlanta, GA (US)

(72) Inventors: Johnny Bernard Lienau, Milwaukee, WI (US); Richard S. Walters, Port Washington, WI (US); Matt Gonia, Hubertus, WI (US); Joe Bonniwell, Grafton, WI (US); Robb Allan Peebles, Cottage Grove, WI (US)

(21) Appl. No.: 14/641,873

(22) Filed: Mar. 9, 2015

Related U.S. Application Data
(60) Provisional application No. 61/949,687, filed on Mar. 7, 2014.

(51) Int. Cl. H01Q 1/27; H01Q 9/16

(52) U.S. Cl. CPC H01Q 1/273; H01Q 9/16

(57) ABSTRACT

A bracelet configured to interface with a mobile device includes: a first housing having a generally semicircular shape; and a second housing having a generally semicircular shape that is hingedly coupled to the first housing. The first housing includes: an inner cover manufactured from a metallic material; and an outer cover comprising at least a first bent plate and a second bent plate each manufactured from a metallic material. The second housing includes: an inner cover manufactured from a metallic material; and an outer cover manufactured from a metallic material. The bracelet also comprises: a plastic insert positioned within the first housing and comprising a plurality of plastic spacing elements positioned at at least an end of the first bent plate, an end of the second bent plate, and between the first bent plate and the second bent plate; and a flexible printed circuit board electrically connected to the first bent plate and the second bent plate. The first bent plate and the second bent plate form an antenna for a radio-frequency communication device mounted on the flexible printed circuit board.

### CROSS REFERENCE TO RELATED APPLICATIONS

This application is based on U.S. Provisional Patent Application No. 61/949,687 entitled “Antenna for a Bracelet Designed to Interface with a Mobile Device”, filed Mar. 7, 2014, on which priority of this patent application is based and which is hereby incorporated by reference in its entirety.

### BACKGROUND OF THE INVENTION

1. Field of the Invention

The present invention is generally directed to a bracelet designed to interface with a mobile device, such as a cellular phone, smart phone, tablet computer, or personal digital assistant, and, more specifically, to an antenna for use with such a bracelet.

2. Description of Related Art

Wearable technology devices are becoming increasingly popular among consumers, particularly in relation to devices worn by a consumer that communicate with a cellular phone in order to provide an indication of an incoming call or text message. Many of these devices have an unappealing appearance and are manufactured from inexpensive materials such as rubber and plastic. Accordingly, it would be desirable to incorporate the alerting capabilities of wearable technology devices into more fashionable articles such as jewelry made from more durable and aesthetically pleasing metallic materials.

However, a problem exists in that it is difficult to position an antenna required for communication between the wearable technology device and the mobile device inside an all metal article, such as a bracelet, such that the antenna functions properly. The difficulty arises because metal is conductive and effectively blocks or redistributes radiation. Placing an antenna inside of a metal bracelet essentially blocks all radio-frequency (RF) communication. An additional problem arises due to the proximity of the human body to the wearable technology device because the human body absorbs RF signals.

Accordingly, a need exists for an aesthetically pleasing wearable technology device that is formed from a metallic material and has an antenna formed from an exterior surface of the device such that the metallic housing of the device will not block or redistribute the radiation of the antenna.

### SUMMARY OF THE INVENTION

An object of the invention is to provide a metal bracelet configured to interface with a mobile device, such as a cellular phone, smart phone, tablet computer, or personal digital assistant, where an exterior surface of the metal bracelet forms an antenna. Such a design allows the exterior metal housing of the bracelet to be used as the main radiator for the antenna, rather than blocking the antenna radiation if the antenna were positioned within the metal housing. Using the exterior of the bracelet as the antenna also helped to solve the body absorption problem. A large radiating element results from the antenna wrapping partially around the wrist, thereby providing a near omnidirectional radiation pattern.

Accordingly, provided is a bracelet configured to interface with a mobile device. The bracelet comprising: a first housing having a generally semicircular shape; and a second housing having a generally semicircular shape that is hingedly coupled to the first housing. The first housing includes: an inner cover; and an outer cover comprising at least a first bent plate and a second bent plate each manufactured from a metallic material. The second housing includes: an inner cover; and an outer cover manufactured from a metallic material. The bracelet also comprises: a plastic insert positioned within the first housing and comprising a plurality of plastic spacing elements positioned at at least an end of the first bent plate, an end of the second bent plate, and between the first bent plate and the second bent plate; and a flexible printed circuit board electrically connected to the first bent plate and the second bent plate. The first bent plate and the second bent plate form an antenna for a radio-frequency (RF) communication device mounted on the flexible printed circuit board.

Also provided is an antenna for use with a bracelet configured to interface with a mobile device. The antenna includes: a first arm formed from a first portion of an exterior housing of the bracelet; a second arm formed from a second portion of the exterior housing of the bracelet; and a plastic spacing element positioned between the first arm and the second arm to electrically isolate the first arm from the second arm. The first arm and the second arm are desirably formed from a metallic material and form a dipole antenna.

These and other features and characteristics of the device of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the device of the present disclosure. As used in the specification and the claims, the singular form of “a”, “an”, and “the” include plural referents unless the context clearly dictates otherwise.

### BRIEF DESCRIPTION OF THE DRAWINGS

FIG. 1 is a schematic view of a conventional dipole antenna;

FIG. 2 is a perspective view of a bracelet incorporating an antenna in accordance with the present invention;

FIG. 3 is an exploded perspective view of a portion of the bracelet of FIG. 2 illustrating the first and second bent plates that form the antenna and a plastic insert;

FIG. 4 is another exploded perspective view of a portion of the bracelet of FIG. 2 further illustrating the flexible printed circuit board; and

FIG. 5 is a perspective view of the bracelet of FIG. 2 in an open position.

### DESCRIPTION OF THE INVENTION

For purposes of the description hereinafter, the terms “upper”, “lower”, “right”, “left”, “vertical”, “horizontal”, “top”, “bottom”, “lateral”, “longitudinal”, and derivatives thereof, shall relate to the device of the present disclosure as it is oriented in the drawing figures. However, it is to be understood that the device of the present disclosure may assume various alternative variations, except where expressly specified to the contrary. It is also to be understood that the specific devices illustrated in the attached drawings, and described in the following specification, are simply exemplary embodiments of the device of the present disclosure. Hence, specific dimensions and other physical characteristics related to the embodiments disclosed herein are not to be considered as limiting.

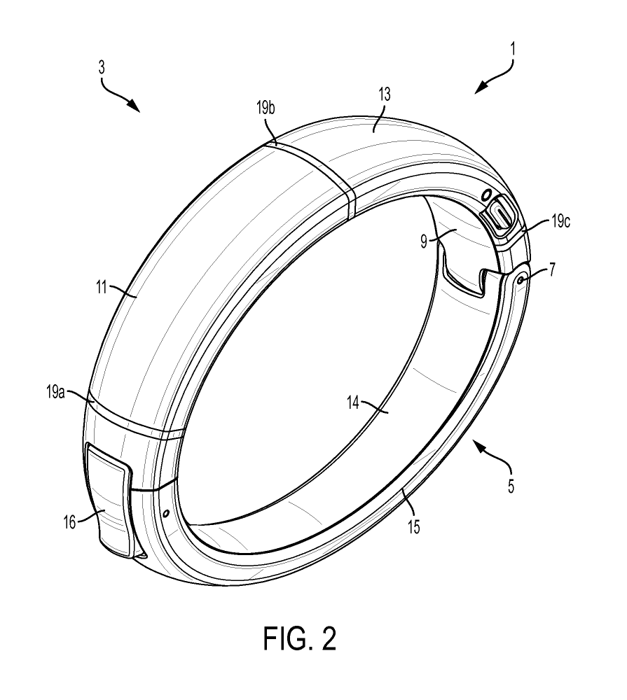

With reference to FIG. 2, a bracelet, generally denoted as reference numeral 1, designed to interface with a mobile device (not shown), such as a cellular phone, smart phone, tablet computer, or personal digital assistant, is provided. More specifically, the bracelet 1 is linked to the mobile device using a Bluetooth communication protocol. Bluetooth is a radio-frequency (RF) specification for short-range, point-to-multipoint voice, and data transfer. The bracelet 1 also includes a notification mechanism (not shown), such as a vibrating mechanism. Using an application loaded on the associated mobile device, the user can program the vibrating mechanism of the bracelet 1 to vibrate when a call is received, when a text is received, at a particular time, and/or when an alarm is set. Accordingly, the bracelet 1 provides the user with an indication that a call and/or text is being received, even if the mobile device associated with the bracelet is remotely located.

Bracelet 1 includes a first housing, denoted generally as reference numeral 3, having a generally semicircular shape; and a second housing, denoted generally as reference numeral 5, having a generally semicircular shape that is hingedly coupled to the first housing 3 by a pin 7. The first housing 3 includes: an inner cover 9; and an outer cover comprising a first bent plate 11 and a second bent plate 13 each manufactured from a metallic material, such as but not limited to, zinc plated with rhodium or gold. The second housing 5 includes: an inner cover 14; and an outer cover 15 manufactured from a metallic material, such as but not limited to, zinc plated with rhodium or gold. A clasp 16 is provided between the first housing 3 and the second housing 5 to allow a user to open and close the bracelet 1.

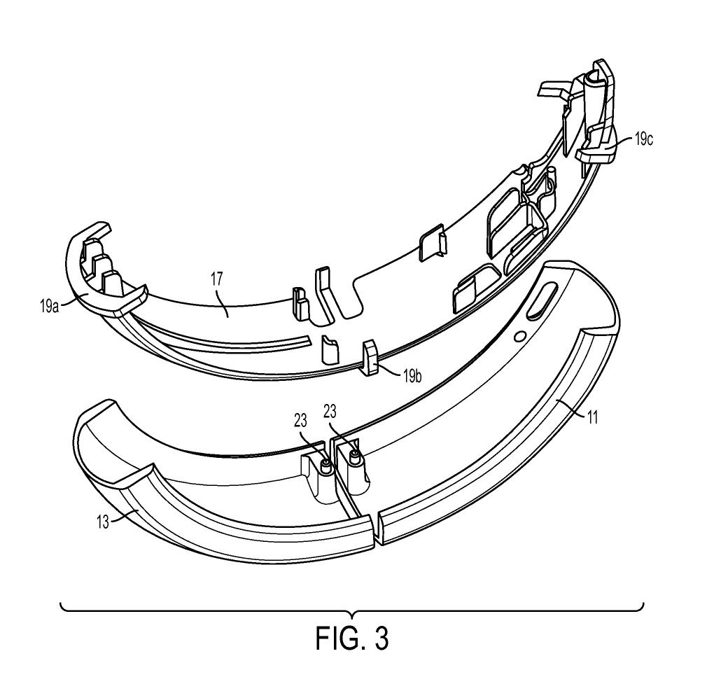

With reference to FIG. 3 and with continued reference to FIG. 2, the bracelet 1 also includes a plastic insert 17 positioned within the first housing 3 and comprising a plurality of plastic spacing elements 19a, 19b, 19c positioned at an end of the first bent plate 11, an end of the second bent plate 13, and between the first bent plate 11 and the second bent plate 13. The plastic spacing elements 19a, 19c positioned at the ends of the first bent plate 11 and the second bent plate 13 electrically isolate the first bent plate 11 and the second bent plate 13 from the inner cover 9 of the first housing 3 and the inner and outer covers 14, 15 of the second housing 5. The plastic spacing element 19b positioned between the first bent plate 11 and the second bent plate 13 is configured to electrically isolate the first bent plate 11 from the second bent plate 13.

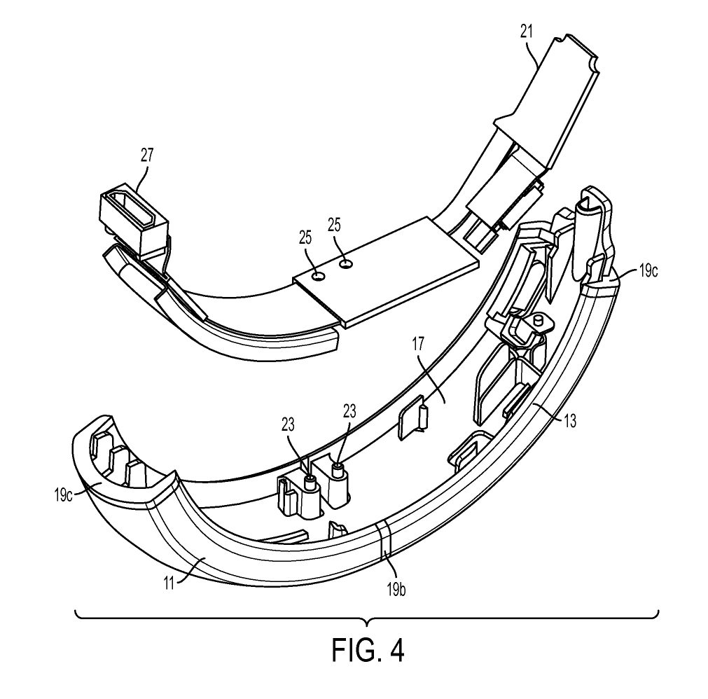

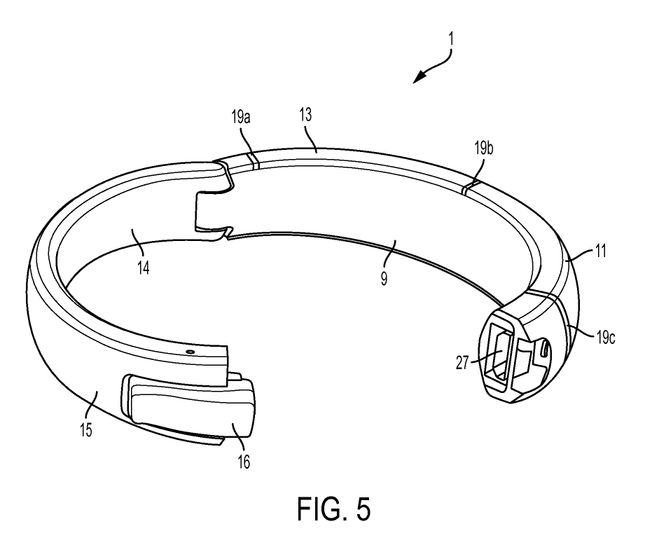

With reference to FIGS. 4 and 5 and with continued reference to FIGS. 2 and 3, the bracelet 1 further includes a flexible printed circuit board 21 having a radio-frequency (RF) communication device (not shown) mounted thereon. The RF communication device is electrically connected to the first bent plate 11 and the second bent plate 13. Soldering pins 23 are molded into the first bent plate 11 and the second bent plate 13 for electrically connecting the first and second bent plates 11, 13 to the flexible printed circuit board 21. The soldering pins 23 are configured to be positioned within mounting holes 25 provided in the flexible printed circuit board 21 and then soldered thereto. A vibration motor (not shown), a power supply (not shown), and a USB connector 27 may also be mounted on the flexible printed circuit board 21.

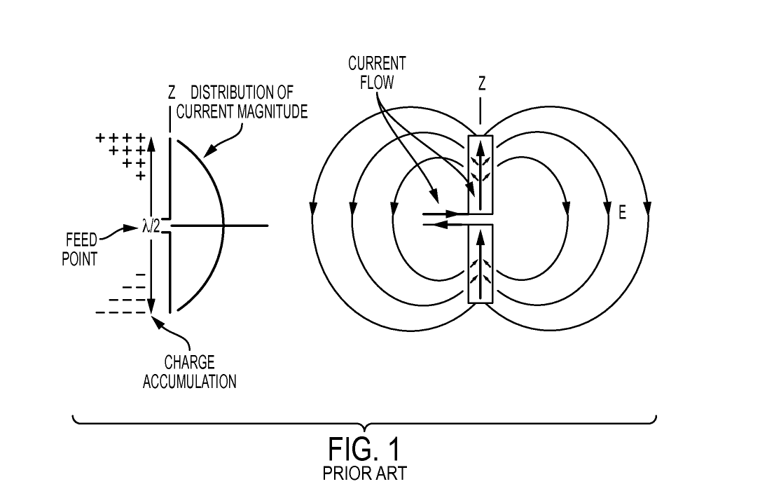

The first bent plate 11 and the second bent plate 13 form dipole antenna for the RF communication device mounted on the flexible printed circuit board 21. With reference to FIG. 1, the antenna uses the first bent plate 11 and the second bent plate 13 of the metal bracelet 1 as its primary radiating element. The antenna is a dipole topology. A dipole antenna essentially includes two charged poles (one positively and the other negatively). Charge builds up on the dipole when a potential is applied to the feed point by an RF transmission line. Negative charge builds up on one end and positive on the other, this causes current to flow along the length of the entire dipole and radiation occurs. A large current develops at the feed point (area of low resistance) and the current goes to zero at the end of the dipole arms (area of high resistance). This relationship can be characterized by the fundamental equation: Voltage=Current*Resistance. Impedance of the dipole remains constant at a given frequency.

Using this fundamental concept, a dipole antenna is created from the two bent plates 11, 13. Each of the bent plates 11, 13 are about 1.1 inches in length and are positioned to point away from each other as discussed hereinabove. These bent plates 11, 13 form the two ends of the dipole and are electrically isolated from the other metal of the bracelet as discussed hereinabove. They are connected to the RF communication device mounted on the flexible printed circuit board 21 via pins 23 that are molded into them and soldered to the flexible printed circuit board 21. Accordingly, these pins 23 are then connected to an RF transmission line (not shown). The plastic spacing elements 19a, 19b, 19c prevent the bent plates 11, 13 from making contact with the rest of the metal exterior (and each other) as discussed hereinabove.

Most conventional dipole antennas are pieces of thin wire or coaxial cable. The dipole antenna of the bracelet 1 of the present invention utilizes two bent plates 11, 13 instead. This allows for better gain and bandwidth from the antenna. The RF communication device and peripheral electronics (motor, battery, USB connector, etc.) are located on flexible printed circuit board 21 positioned within the first housing 3 underneath the two bent plates 11, 13 that form the dipole arms. This creates a ground plane underneath the antenna, and adds capacitance. The plastic spacing elements 19a, 19c at the end of the two bent plates 11, 13 maintain separation between the antenna and the decorative metal of the bracelet 1. If the metal of the bracelet 1 was capable of touching the antenna, the current flow on the antenna would be disrupted and a severe reduction of the radiation would occur. The plastic spacing element 19b between the two bent plates 11, 13 has a similar effect. The two bent plates 11, 13 must remain electrically isolated from each other until they reach the feed point where they meet the RF transmission line.

The present invention provides several advantageous features. First, a main advantage of using an exterior housing of the bracelet 1 as the antenna is to avoid the negative effects of having metal near an antenna. One of the main challenges of antenna design is limiting the amount of metal nearby. As an antenna radiates, the energy leaving it will induce currents on nearby metal. As a result of this, those pieces of metal in turn then reradiate the energy. This will interfere with the antenna radiation and dramatically reduce performance, and in some cases completely block all radiation. Since the bracelet 1 of the present invention is all metal, trying to put an antenna inside its housing would not have worked due to this effect. Making a large portion of the metal bracelet 1 into the actual antenna effectively reduces the amount of metal nearby and simultaneously moves the antenna out from “inside” the bracelet 1 where it would have been encompassed by metal.

An additional advantage of the antenna of the bracelet 1 of the present invention is its large size. In antenna design, larger antennas provide better bandwidth, gain, and are less susceptible to manufacturing tolerances. The antenna formed by the first and second bent plates 11, 13 is about 2.5 inches in length, which is extremely large for a compact, Bluetooth, consumer device.

While specific embodiments of the device of the present disclosure have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the device of the present disclosure which is to be given the full breadth of the claims appended and any and all equivalents thereof.

The invention claimed is:

1. A bracelet configured to interface with a mobile device, the bracelet comprising:
a first housing having a generally semicircular shape and comprising:
an inner cover; and
an outer cover comprising at least a first bent plate and a second bent plate each manufactured from a metallic material;
a second housing having a generally semicircular shape that is hingedly coupled to the first housing and comprising:
an inner cover; and
an outer cover manufactured from a metallic material;
a plastic insert positioned within the first housing and comprising a plurality of plastic spacing elements positioned at at least an end of the first bent plate, an end of the second bent plate, and between the first bent plate and the second bent plate; and
a flexible printed circuit board electrically connected to the first bent plate and the second bent plate,
wherein the first bent plate and the second bent plate form an antenna for a radio-frequency (RF) communication device mounted on the flexible printed circuit board.

2. The bracelet of claim 1, wherein the plastic spacing elements positioned at the ends of the first bent plate and the second bent plate electrically isolate the first bent plate and the second bent plate from the inner cover of the first housing and the inner and outer covers of the second housing.

3. The bracelet of claim 1, wherein the plastic spacing element positioned between the first bent plate and the second bent plate electrically isolates the first bent plate from the second bent plate.

4. The bracelet of claim 1, wherein a vibration motor, a power supply, a USB connector, or any combination thereof are mounted on the flexible printed circuit board.

5. The bracelet of claim 1, wherein at least one pin is molded into the first bent plate and at least one pin is molded into the second bent plate for electrically connecting the first and second bent plates to the flexible printed circuit board.

6. The bracelet of claim 5, wherein the pins are soldered to the flexible printed circuit board.

7. The bracelet of claim 1, further comprising a clasp provided between the first housing and the second housing to allow a user to open and close the bracelet.

8. An antenna for use with a bracelet configured to interface with a mobile device, the antenna comprising:
a first arm formed from a first portion of an exterior housing of the bracelet;
a second arm formed from a second portion of the exterior housing of the bracelet; and
a plastic spacing element positioned between the first arm and the second arm to electrically isolate the first arm from the second arm.

9. The antenna of claim 8, wherein the first arm and the second arm are each formed from a metallic material.

10. The antenna of claim 8, wherein the first arm and the second arm form a dipole antenna.
